(19) United States
(12) Patent Application Publication
(10) Pub. No.: US 2018/0357599 A1
(43) Pub. Date: Dec. 13, 2018

(54) SYSTEMS, METHODS, AND DEVICES FOR AUTOMATICALLY MONITORING AND MESSAGING PRODUCT DISPENSING SYSTEMS

(71) Applicant: Huge, LLC, Brooklyn, NY (US)

(72) Inventors: Aaron SHAPIRO, New York, NY (US); Elio ACINAPURA, New York, NY (US)

(21) Appl. No.: 16/006,528

(22) Filed: Jun. 12, 2018

Related U.S. Application Data
(60) Provisional application No. 62/518,473, filed on Jun. 12, 2017.

(51) Int. Cl. G06Q 10/08

(52) U.S. Cl. CPC G06Q 10/087; G06N 99/005

(57) ABSTRACT

Devices and methods for automatically monitoring a product quantity and sending a message based thereon, involving a sensor for monitoring an amount of a product consumed or remaining, and involving, based on the monitoring by the sensor of the product, sending or transmitting a message. Such devices and methods where the product is a liquid housed within a container.

### FIELD

Embodiments of the present invention relate generally to systems, methods, and devices for monitoring and messaging consumable products and/or services, including water bottle products and/or water bottle refilling services.

### BACKGROUND

Large, multi-use water bottles and dispensing systems which make use of such water bottles are popular in home and office environments. Eventually, after enough uses, these bottles run out of water and a new water bottle must be inserted. If a user does not have a spare water bottle on hand and desires more water, he or she can make a trip to the store for new water bottles, or contact a water bottle delivery service. The user can also arrange for periodic delivery of water bottles. Attempts have been made to determine the amount of water remaining in water bottles by measuring flow out of the bottles, but this has not worked well.

There have been advances in conveniently ordering products. The Amazon Dash Button, for example, provides a Wi-Fi connected device that can be used by a consumer to reorder products, for example, reordering laundry detergent by pressing a button that has been affixed to a laundry machine.

However, the inventors of the present invention have realized that none of the above water bottle or others systems actually of provide automatic monitoring of the amount of a product (such as water) or automatic messaging or ordering in response to changes in this amount.

### SUMMARY

Embodiments of the present invention can provide systems, methods, and devices for automatic monitoring of the amount of a product, such as water, and for messaging or ordering in response to changes in this amount. In further embodiments of the present invention, systems, methods, and devices may collect business information, for example for a parent company.

### BRIEF DESCRIPTION OF THE DRAWINGS

FIG. 1 is a flow chart showing an exemplary method according to embodiments of the invention of ordering water, monitoring water consumption, messaging and/or reordering water, and delivering water.

FIG. 2 is a flow chart showing an exemplary method according to embodiments of the invention of ordering water, monitoring water consumption, messaging and/or reordering water, and delivering water, employing machine learning.

FIG. 3 is a flow chart showing an exemplary method according to embodiments of the invention of ordering water, monitoring water consumption, messaging and/or reordering water, and delivering water, employing machine learning, further showing system aspects and components, specifically, Hybris, RMS and a unique user account, used in connection therewith.

FIG. 4 is an exemplary breadboard diagram for a device used in according to embodiments of the present invention.

FIG. 5 is an exemplary wiring schematic for a device used in according to embodiments of the present invention.

### DETAILED DESCRIPTION

According to embodiments of the present invention, a device is provided that monitors an amount of a product, such as water, and messages a user and/or reorders the product based on this monitoring. While embodiments of the present invention will be discussed in connection with water, it will be understood that other product(s) may be monitored and messaging and/or reordering may occur with respect to those other product(s). By way of nonlimiting example, such other product(s) may include other liquid and/or flowing products (other beverages such as soda, liquid soap, detergent, cereal, pet food, etc.) or other items susceptible to automated amount monitoring by the devices and methods discussed herein (for example, toilet paper).

In other embodiments of the present invention, a device is provided that monitors an amount of a product, and takes other action based on the results of the monitoring. Such other action may be an automatic action and/or an action triggered by the results of the monitoring. Such other action may be a computer activity, by way of example, a database entry being created or a light turning on or off.

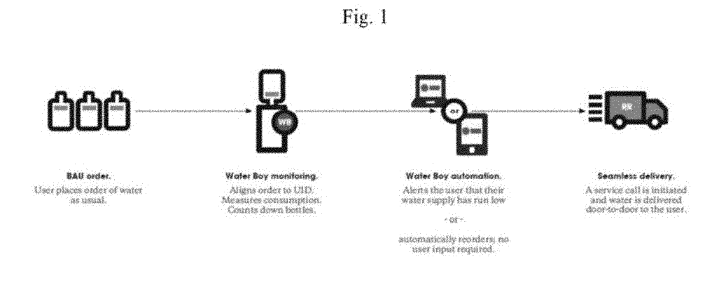

FIG. 1 is a flow chart showing an exemplary method according to embodiments of the present invention of ordering water, monitoring water consumption, messaging and/or reordering water, and delivering water. Initially, the user of the water dispensing system (which may, for example, be a top-loading system) either has or orders a quantity of water. The quantity of water, which may be understood and expressed in terms of the number of full bottles of water and/or the amount of water remaining within a used or partially used water bottle, is monitored by the water dispensing system and/or by a system in communication with the water dispensing system.

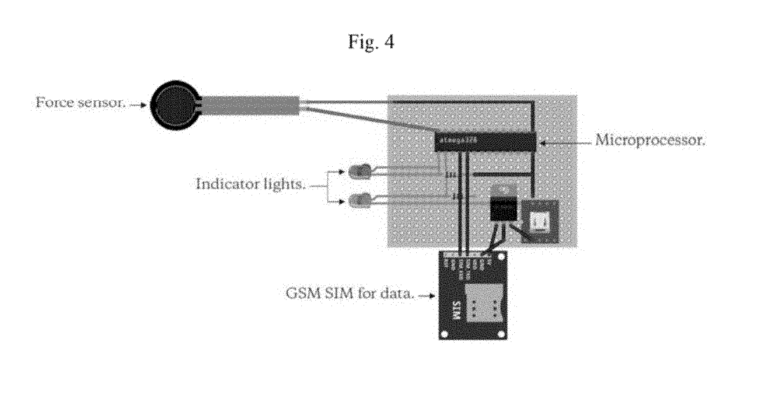

A force sensor (such as is shown in FIG. 4) may be employed in connection with this monitoring, which measures the weight of the water bottle(s) that has or have been loaded into the machine. A proportion of water remaining in the bottle can be determined, for example by the formula:

(measured bottle weight−empty bottle weight)/(full bottle weight−empty bottle weight)

Moreover, the complete consumption of a bottle can be determined when the measured bottle weight approximates the empty bottle weight of zero (in the case of bottle removal). Similarly, the insertion of a new bottle can be determined when the weight changes so as to drastically increase or approximate the full bottle weight. Other means may be used, for example, a bar code reader on the device that reads unique identifiers from the bottles to determine when they have been changed.

In this manner, the total water consumption (which may include water consumption rate) can be monitored. It also may be compared against the quantity or quantities ordered to determine the amount of water remaining in the user's possession. These ordered quantities can be obtained by an analysis of past orders, or these amounts may he inserted by the user. Alternately, the user can simply provide the system with a current quantity of water. If the amount of water remaining becomes less than and/or equal to some predetermined amount (for example, 2 bottles, 1 bottle, or 25% of a bottle) a message may be sent to the user that their water supply has run low and/or that it is time to refill and/or reorder. Such a message may take the form of a text message, email, automated phone call, or other means of communication as are known in the art. Such messages may, for example, convey that the user should reorder water, or may simply convey that the current water bottle is largely used up or used up to some predetermined level and should be changed soon. Instead of or in addition to a message being sent to a user, a reorder of water bottles may occur automatically or upon electronic confirmation from the user. Messages may include such information as “running low,” “container empty,” and/or “battery low.” The water may then be delivered to the user, for example through the automated reordering process and/or through the initiation of a call by the user. The amount of water remaining that is monitored may be incremented accordingly, and the process may repeat.

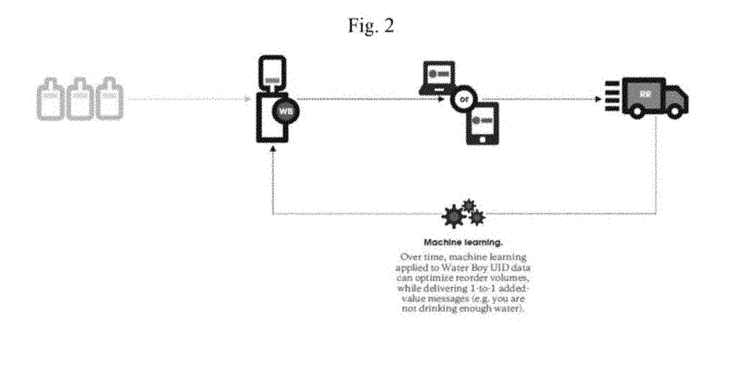

FIG. 2 is a flow chart showing an exemplary method according to embodiments of the invention of ordering water, monitoring water consumption, messaging and/or reordering water, and delivering water, employing machine learning (which may operate, for example, on data collected through a service layer for data collection). A unique identifier (“UID”) can apply to data obtained by a particular water dispensing system, which data can be used, through machine learning, to optimize reorder volume. The water consumption may be aligned to a UID via cellular. Such optimization can take into account such factors as delivery cost, delivery time, user delivery preferences, cost or assumed cost for the user to store water bottles or available space for water storage, and seasonal or temperature-based water consumption effects. By way of example, the following factors might tend in favor of the following associated water reordering practices (with the inverse relationships also being potentially applicable) in the machine learning process:
high user consumption during the current season (earlier reordering, i.e., when amount of water remaining is not as low, higher reorder volumes);
high user consumption rate in general (earlier reordering, i.e., when amount of water remaining is not as low, higher reorder volumes);
high anticipated temperatures in the user's location (earlier reordering, higher reorder volumes);
high water storage availability and/or lower water storage costs (earlier reordering, i.e., when amount of water remaining is not as low, higher reorder volumes);
high delivery time (earlier reordering);
long time between reorders (lower reorder volumes);
higher delivery cost per order (higher order volume).

Predictive analytics may be employed.

Such machine learning based order practices could be applied automatically to orders, and/or used for suggestions incorporated in messages to the user. As an additional example, such an analysis may be used to send messages to the user, if the known number of individuals at the user's location would tend to suggest that the amount of water being consumed is less than advisable from a health perspective, that those individuals are not drinking enough water.

Indications of customer satisfaction, customer retention ands or customer profitability, from the user or from other users, may be used as part of the machine learning process to adjust the recommendations and/or reorders. For example, if it is determined that customer satisfaction and/or retention tends to drop as automated reorder volumes exceed a particular threshold, then the machine learning process may suggest lower reorder volumes if they would otherwise be at or above that threshold.

Adjustments may also he made according to user demographics, such as whether the user is in a home or office setting.

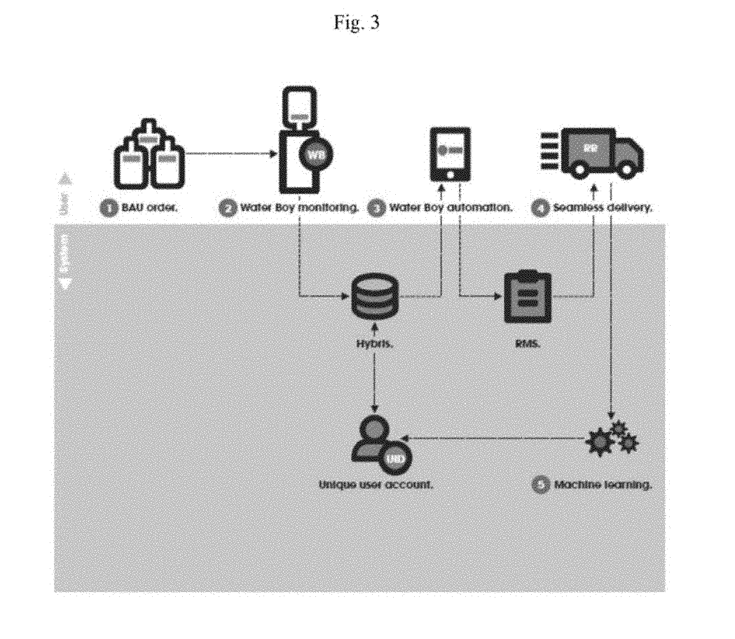

FIG. 3 is a flow chart showing an exemplary method according to embodiments of the invention of ordering water, monitoring water consumption, messaging and/or reordering water, and delivering water, employing machine learning, further showing system aspects and components, specifically, Hybris (that is, Hybris Data Lake), RMS (used for product fulfillment) and a unique user account, (associated with a unique identifier/“UID”) used in connection therewith. Consent value(s) associated with the UID may be acquired through, for example, ExactTarget, Hybris CMS, and/or other use engagement delivery points.

FIG. 4 is an exemplary breadboard diagram for a device used in according to embodiments of the present invention. A sensor, which may be a force sensor, is used to determine the amount of water and/or the number of bottles consumed. Other sensors may be used in other embodiments, for example, camera-based sensors, tactile or moisture sensors located within the bottle, sensors for determining the water flow out of the water dispensing system, or other sensors for determining the volume of liquid remaining as may be known in the art. It will be understood that adaptations to the sensor may be made based on the particular top-loading, bottom-loading, or other water dispensing system used by the user. Custom bases and/or attachments may be employed as necessary to operate with these water dispensing systems, and may be made, for example, by 3d-printing, machining, or casting. For example, the device may be attached to the water dispensing system, for example, with Velcro, and this may occur without modification to an existing, sensor unit. A microprocessor may be used for the manipulation and/or storage of data obtained by the sensor. Indicator lights may be used, for example, to signal errors or whether the device is functioning. A GSM SIM or other communications device may be used to transmit messages and/or reorders such as are described herein. it will be understood that the device may connect to the Internet according to the specifications of the user's home or office system. Such networking structure as is known in the art, for example, that employed in connection with the Amazon Dash Button, may be employed, A server or servers separate from the device may be used, for example, for the processing of acquired data, for the sending of messages, for reordering, for operating machine learning routines, and/or for handling of technical exceptions. The server may be connected to the device, for example, by cables, through WiFi, or over the Internet An Internet-of-Things (“IoT”) model may be used for the network architecture. Device software, a consolidation and/or communications hub, and/or a device administrative console may be employed. The software components may manage communications with the hub, via, for example, the public interwebs. The hub may process and respond to messages received from a device or devices, retain a directory of those devices and/or integrate with their customer SoR and fulfillment systems. An ESB may be leveraged to process and/or raise events. A directory may be stored in a repository. The administrative console may employ a user interface for the set-up, configuration and/or removal of devices. For example, HTTP/JS, connecting with a set of java services may be used. Components in certain embodiments may include a SIM800c or other GSM cellular radio, a FSR406 or other force sensitive resistor, an Atmega328 or other microcontroller and/or CPU, a SIM card/Data plan or other mechanism for providing a data connection, and/or additional circuit components (including, for example a voltage regulator, a housing, a circuit board, and resistors).

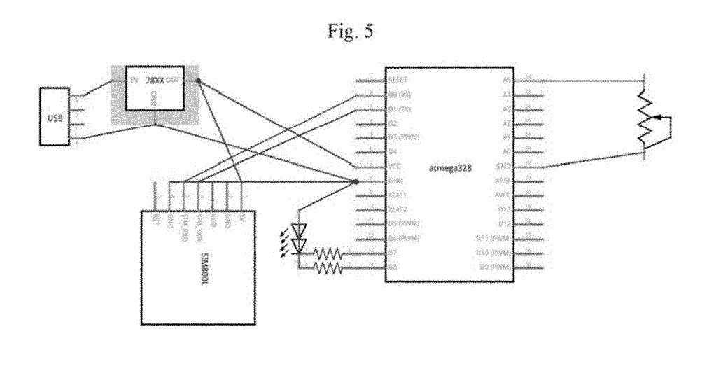

FIG. 5 is an exemplary wiring schematic for a device used in according to embodiments of the present invention, providing additional detail as to how the breadboard diagram of FIG. 4 may be programmed to operate.

The embodiments and examples shown above are illustrative, and many variations can be introduced to them without departing from the spirit of the disclosure. For example, elements and/or features of different illustrative and exemplary embodiments herein may be combined with each other and/or substituted with each other within the scope of the disclosure. For example although exemplary embodiments are described as being used with water, it is understood that the systems and methods may be used with other liquids and solids that are capable of measurement. For a better understanding of the disclosure, reference should be had to any accompanying drawings and descriptive matter in which there is illustrated exemplary embodiments of the present invention.

What is claimed is:

1. A device for automatically monitoring a product quantity and sending a message based thereon, comprising:
a sensor for ruminating a quantity of product consumed;
a processor for determining an amount of product remaining based on information from the sensor regarding the quantity of product consumed and based on information regarding a quantity of product purchased and generating a message regarding the amount of product remaining;
a communications device for transmitting the message.

2. The device of claim 1, wherein the product is dispensed from a preexisting dispenser, wherein the sensor is adapted to be attachable to, and to monitor the quantity of product consumed from, the preexisting dispenser.

3. The device of claim 1, further comprising a product dispenser for dispensing the product, wherein the sensor is integrated with the product dispenser.

4. The device of claim 1, wherein the sensor is a force sensor.

5. The device of claim 4, wherein the force sensor measures the weight of the product.

6. The device of claim 1, wherein the processor generates the message using machine learning.

7. The device of claim 1, wherein the message is sent to a user to inform the user that the amount of product remaining is low.

8. The device of claim 1, wherein the message is a reorder request to a supplier of the product.

9. The device of claim 8, wherein the message is sent without confirmation from the user.

10. The device of claim 7, wherein the message is sent when the amount of product remaining is determined to be approximately 25% of a bottle.

11. The device of claim 7, wherein the message is sent When the amount of product remaining is determined to be approximately 0% of a bottle.

12. The device of claim 1, wherein the message is generated based on a machine learning process.

13. The device of claim 12, wherein a reorder quantity that is part of the message is determined using the machine learning process.

14. The device of claim 12, wherein the machine learning process determines and incorporates a consumption rate of a user.

15. The device of claim 12, wherein the machine learning process incorporates one or more of: user consumption during the current season, anticipated temperature, delivery time, time between reorders, and delivery cost per order.

16. The device of claim 12, wherein the machine learning process employs predictive analytics.

17. The device of claim 1, wherein the message is generated on a determination of insufficient product consumption, and wherein the message is an indication that more product should be consumed.

18. The method of claim 1, wherein the product is a liquid housed within a container.

19. The method of claim 18, wherein the product is water.

20. A method for automatically monitoring a product quantity and sending a message based thereon, comprising:
using a sensor to monitor an amount of a product remaining;
based on the amount of product remaining, and without human intervention, sending a message.

21. The method of claim 20, wherein the product is a liquid housed within a container.

22. The method of claim 21, wherein the product is water.

23. The method of claim 20, wherein the sensor is a force sensor.

24. The method of claim 23, where the force sensor measures the weight of the product.

25. The method of claim 20, Wherein the message is sent to a user to inform the user that the amount of product remaining is low.

26. The method of claim 20, wherein the message is a reorder request to a supplier of the product.

27. The method of claim 26, wherein the message is sent without confirmation from the user.

28. The method of claim 25, wherein the message is sent when the amount of product remaining is determined to be approximately 25% of a bottle.

29. The method of claim 25, wherein the message is sent when the amount of product remaining is determined to be approximately 0% of a bottle.

30. The method of claim 25, wherein the monitoring includes monitoring of a number of bottles of product consumed.

31. The method of claim 26, wherein the message is sent based on a machine learning process.

32. The method of claim 31, wherein a reorder quantity that is part of the message is determined using the machine learning process.

33. The method of claim 31, wherein the machine learning process determines and incorporates a consumption rate of a user.

34. The method of claim 31, wherein the machine learning process incorporates one or more of: user consumption during the current season, anticipated temperature, delivery time, time between reorders, and delivery cost per order.

35. The method of claim 31, wherein the machine learning process employs predictive analytics.

36. The method of claim 22, wherein the message is based on a determination of insufficient water consumption, and wherein the message is an indication that more water should be consumed.
